(19) United States
(12) Patent Application Publication
(10) Pub. No.: US 2010/0100257 A1
(43) Pub. Date: Apr. 22, 2010

(54) Visual airport surface and terminal area data system

(76) Inventors: Chris Brinton, Leesburg, VA (US); Steve Atkins, Westford, MA (US); Jeremy Lindsey, Leesburg, VA (US)

Correspondence Address: BERENATO & WHITE, LLC, 6550 ROCK SPRING DRIVE, SUITE 240, BETHESDA, MD, 20817, US

(21) Appl. No.: 12/255,761

(22) Filed: Oct. 22, 2008

(51) Int. Cl. G06F 17/00

(52) U.S. Cl. 701/3

(57) ABSTRACT

The invention supports the study of operations and provides a large data store of surface and terminal area operations, as well as means of analyzing and understanding that data. It fuses multiple surveillance and flight data sources to provide analysis functionality for both airborne and surface based flights. This provides a wider range of data to make intelligent categorization and derived data analysis decisions. The invention implements custom logic for matching flights to corresponding data messages by maintaining its own key mappings between data tables during import so that keys are unique to an installation and do not require sequences. This provides the ability to export datasets through the PostgreSQL dump utility and then import it into an existing database (using the PostgreSQL restore utility) without creating overlapping, duplicate or conflicting keys. XML based format is used and import and export features is that allow users to share these custom queries.

### STATEMENT REGARDING FEDERALLY SPONSORED RESEARCH OR DEVELOPMENT

This invention was made with Government support under contract NNA06BA02C awarded by NASA. The Government has certain rights in this invention.

### BACKGROUND OF THE INVENTION

1. Field of the Invention

The present invention relates generally to storing, sharing, searching, visualizing, and analyzing airport surface and terminal area data.

2. Background

Currently there are a number of solutions for either surface or airborne flight data analysis. These solutions fail to meet the needs of the industry because they do not allow significant analysis across these data sources. It would be desirable to have a composition that fuses both airborne and surface data which/that can be used to analyze the complete life span of a flight. Therefore, there currently exists a need in the industry for a composition that fuses flight airborne and surface based flight data allowing complete flight analysis.

### SUMMARY OF THE INVENTION

The present invention advantageously fills the aforementioned deficiencies by providing a tool for storing, sharing, searching, visualizing, and analyzing airport surface and terminal area data. The present fills the need for effective post analysis of airport surface operations and for preparing configuration (adaptation files) for allowing other applications to effectively gather that data. These objectives are fulfilled through two main capabilities supporting analysis of airport surface operations and developing and maintaining airport adaptations for decision support automation such as the Surface Management System (SMS).

The present invention provides a user friendly graphical interface by which a user may analyze past airport surface operations data without database programming or querying experience. The invention allows users to select data elements with which they are familiar (fields) and limit the returned values by setting conditional value constraints (filters) on additional fields. While the inventions database querying interface might be applied to a number of industries, its default configuration files define fields and filters relevant for aviation and related data.

The core logic aims to handle most data interaction in a generic manner, allowing users or administrators to alter or replace its configuration files in order to add fields or target other types of data. Changes to configuration can also allow the query interface to work with other databases.

The present invention has the ability to ingest large quantities of data and organize and store it a manner that aids future analysis. During this importing process the invention does some automated analysis work of its own so that certain derived data values can be made available to users without the need for them to perform this analysis themselves. Thus the invention both performs analysis of airport surface operations as well as provides an interface for users to perform additional analysis efforts.

Furthermore, the present invention can ingest aircraft position data, store it in a database, and compute additional derived data elements also is stored in the database. Additional flight data can also be stored in the database. The Client allows users to define queries through a simple graphical user interface. Results of queries can be plotted on a map of the airport, graphed, displayed in a table, or exported to a file for additional analysis outside of the tool.

Still further, the present invention tool can automatically generate certain SMS adaptation files from airport survey data in the industry standard shape file format. The SODAA Client allows the user to manually edit airport adaptation data using a graphical interface and re-save the updated adaptation files.

Finally, it is an object of the present invention to provide a tool for storing, sharing, searching, visualizing, and analyzing airport surface and terminal area data that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a depiction of a flight splitting routine.

FIG. 2 shows a schematic overview of the present invention.

FIG. 3 shows the flight matching routine.

FIG. 4 shows the flight processing routine.

### DETAILED DESCRIPTION OF THE INVENTION

The present invention is directed to a tool for storing, sharing, searching, visualizing, and analyzing airport surface and terminal area data.

The invention fuses multiple surveillance and flight data sources to provide analysis functionality for both airborne and surface based flights. This provides a wider range of data to make intelligent categorization and derived data analysis decisions. The invention implements custom logic for matching flights to corresponding data messages by maintaining its own key mappings between data tables during import so that keys are unique to an installation and do not require sequences. This provides the unique feature of being able to export datasets through the PostgreSQL dump utility and then import it into an existing database (using the PostgreSQL restore utility) without creating overlapping, duplicate or conflicting keys. In this way SODAA data imports need to be done only use. Later uses can share previously processed datasets after a quick restore. The invention uses an XML based format for saving users' query definitions, and has import and export features that allow users to share these custom queries with other users. Saving query definitions in XML, lessons dependence on any particular database query language or schema.

The primary display screen consists of a user navigable airport surface map. This map supports zooming in and out as well as repositioning. Users may choose for their query results (of flight position based queries) to be displayed as plot points on this map. This creates a graphical representation of flights geographical progress over time. Multiple plots can be drawn to the map at the same time, with user configurable coloring. Geographical or TRACON maps can also be included in the display. These plots can be exported, for example as MPEG or SVG files.

The present invention also includes a custom data viewer grid window that allows users to dynamically regroup query results, by dragging and dropping columns into a preferred order. Using the data viewer, users may select rows (after grouping an finding desired flights) to be automatically plotted onto the airport surface map, without needing to manually create a second query. The present invention will automatically find the position data for only the desired flights and draw them accordingly.

The present invention can also be used for creating airport specific configuration files (adaptation) that can be used to allow the invention and other surface operations decision support systems to effectively process and analyze data for the desired airport. This is done by using SODAA's graphical display of the airport to manually mark and label the important elements—including runways, spots, gates, intersections, etc.

One of the present inventions query plotting options provides the user with a snapshot of where each flight with current data is at a single specified time. The present invention can also take a series of these snapshots and merge them into an animated video file, based on the time range designated by the user. This provides users the ability to replay surface operation events at the airport under analysis.

Flight categories are determined, using three possible sets of logic. All three conditions may be determined using the current position of the flight and the position at which the flight was first monitored by the airport. Under the first condition, if the two points are of sufficient distance, the flight category is determined by comparing the flight position to the airports geographic location. If the flight points do not comply with the first is conditions requirements, the points will be evaluated using the second condition. Under the second condition, flight altitude is evaluated to determine the flight category, assuming there is a sufficient difference in altitude between the two points. If the points fail to comply with the second conditions requirements, the points will be evaluated using the third condition. Under the third condition, if there is sufficient distance and time between the two points, each point will be assigned a gate, determined by the points proximity to all airport gates. The points proximities to their assigned gates will be evaluated to determine flight category. In the event that none of the above conditions can be satisfied, the flight category will not be determined.

Assigning a Spot to a flight requires the definition of a flight taxi route. The intersections bounding each link of the taxi route are evaluated to determine if an intersection can be considered a Spot. After compiling a database of possible Spot values, each Spot is compared against the aircraft track data. Aircraft track data outside of a predetermined distance threshold are not considered likely candidates for determining Spot assignation. The Spot comparison resulting in the minimum distance of all other comparison will be assigned as the flights Spot.

The present invention provides a Java programming interface for third party developers to create their own types of queries. The invention can automatically integrate properly configured, basic plug-in queries into its user interface and SQL generation logic, and results display options. Alternatively third party developers can configure their queries to override the invention's default user input controls, query logic, and output display as desired. This allows third party developers to use the invention to execute new and unique queries against its collection of imported data.

Third party Java developer may also create plug-in logic for the invention to use in calculating additional derived value fields. The invention will include this logic when processing flights during data import.

This allows the invention to perform customized logic to determine values of yet to be created database fields, without needing to update the invention itself. These additional values can then be made available for queries by adding the appropriate XML field definitions.

The invention implements custom logic for matching flights to corresponding data messages by maintaining its own key mappings between data tables during import so that keys are unique to an installation and do not require sequences. This provides an invention with the unique feature of being able to export datasets through the PostgreSQL dump utility and then import it into an existing database (using the PostgreSQL restore utility) without creating overlapping, duplicate or conflicting keys. In this way the invention data imports need to be done only use. Later uses can share previously processed datasets after a quick restore.

The invention uses its own SQL generation logic for converting users field and filter selections into syntax that the underlying database can interpret and execute. These fields and filter options are defined in an external XML file that can be edited by the user to create additional new query options, or to support limited changes to the underlying database implementation and structure.

The invention uses an XML based format for saving users query definitions. The system also has import and export features that allow users to share these custom queries with other users. Saving query definitions in XML, lessons the invention's dependence on any particular database query language or schema.

The invention contains a geospatial region editor, with which users can graphically outline a region of interest on a map, using their mouse. They may then incorporate this custom region into a database query. This can be done as a geospatial query in which data is returned for all flight position points within the designated region(s) or as a filter to any other SODAA generate query to limit results to flights with points within the region(s).

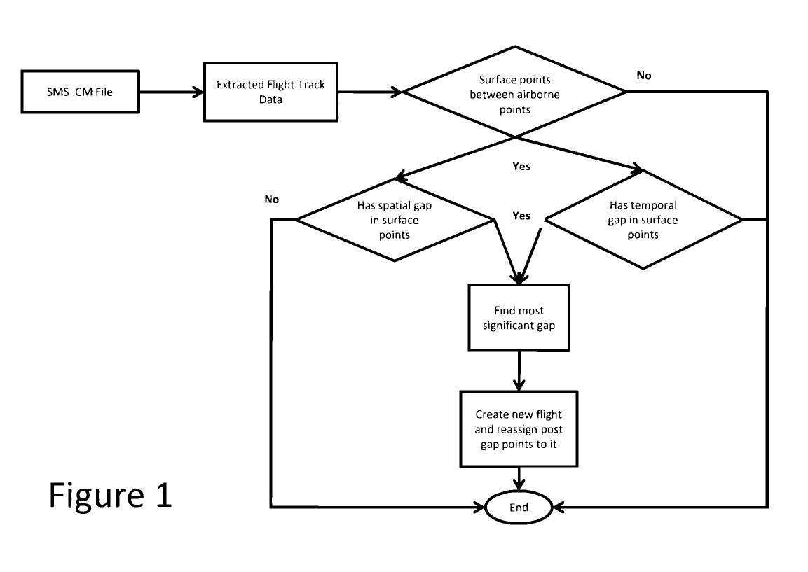

Turning now to the figures, FIG. 1 shows the Flight Splitting Diagram, which outlines how the present invention divides flight track points to properly define unique flights. The typical scenario in which splitting is necessary occurs when a flight lands and departs again without changing its call sign. These situations initially appear as a single flight until SODAA analyzes them more closely. This analysis includes identifying the occurrence of these scenarios by looking for flights that have surface points with airborne points both before and after. The flights are then split at the points where that largest spatial or temporal gaps occur, assuming this to be the point where the flight was at a gate. This splitting insures that when derived data values are calculated for individual flights—they are done using the appropriate track points.

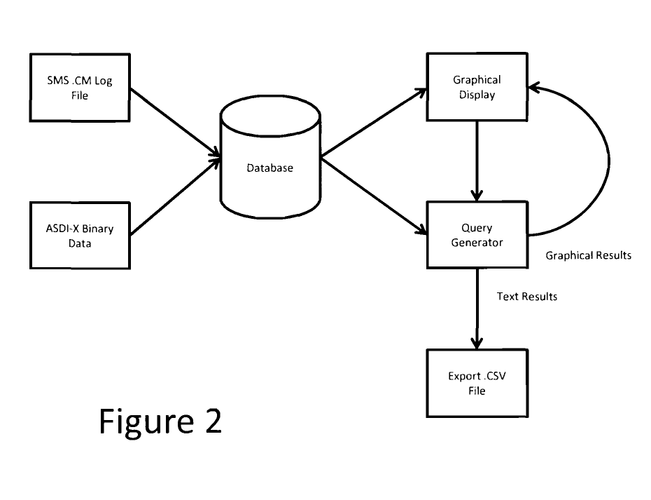

FIG. 2 summarizes the organization and usage of a typical installation. Flight information, coming from either SMS CM log files or ASDI-X binary data, is extracted during the import process. This data is inserted into the database. Using the graphical display within SODAA, users can select the fields that they are interested in and allow SODAA's query generator to retrieve the corresponding data. This data can then be exported to Comma Separated Value (CSV) files or to various graphical output formats.

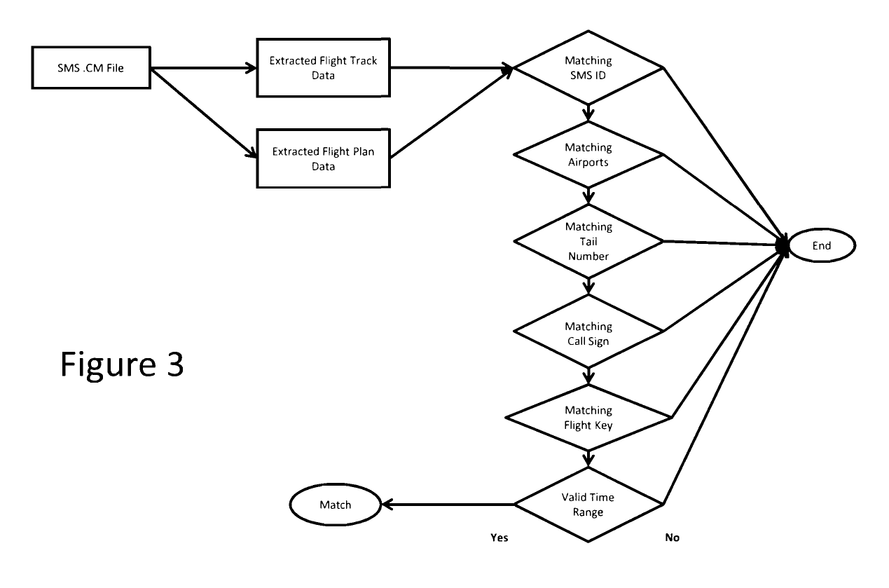

FIG. 3 shows flight matching, which is at the core of the invention's ability to properly associate incoming data to the correct flight records. The Flight Matching diagram summarizes how this flight matching occurs. The invention analyzes both flight track and flight plan data that it extracts from imported data. It then uses several indicators to determine whether the flight details suggested by the current flight data represent an is association to a previously defined flight record. Matching SMS ID numbers, tail numbers, call signs, or flight keys are all used a indicators of whether a new flight matches a previous flight. The invention also insures that potentially matching flights have consistent arrival and departure airports and that they their data points are within a relevant time window. If these checks suggest that the incoming data matches a previously identified flight, then it is associated accordingly. If any of these tests indicate a mismatch, then a new flight record is create for the current data to be associated with.

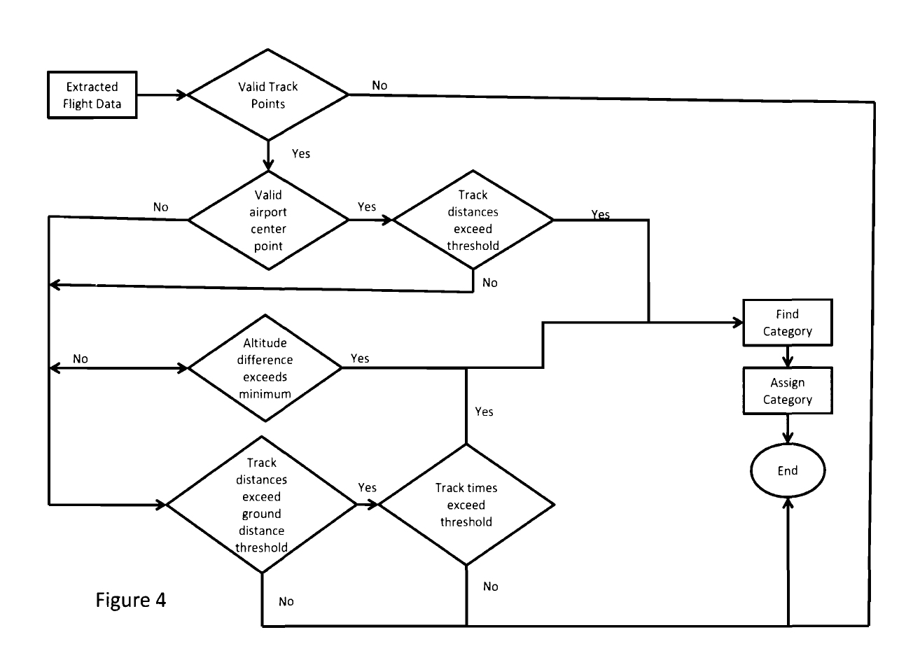

FIG. 4 show flight processing. For each flight processed, if the flight contains valid track data it will be put through a progressive series of checks to categorize the flight as an arrival, a departure, or unknown. If the flight does not contain valid track data the algorithm ends and the category is marked as unknown. The first check requires that an airport center point be specified and the distance between the first and last track points exceeds a minimum distance. If the data passes these two attributes of the first check, distance algorithms will be used to determine the flight category and the algorithm will end. If either of the two attributes of the first check fails, the algorithm will progress to the second check. The second check verifies that there is a significant difference in altitude between track points. If there is a significant distance in altitudes, the difference in altitudes will be used to determine flight category and the algorithm will end. If the second check fails, the algorithm will progress to the third check. The third check verifies that there is significant distance between the first and last track points and that the track points have been monitored for a significant amount of time. If these two attributes are met, the algorithm will categorize the flight based on track point proximities to the nearest airport gate. If either of two attributes of the third check fails, no flight category can be determined and the algorithm will end.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A computer program product made up of a computer usable medium and computer readable program code means embodied in said medium for providing visual airport surface and terminal area data said computer readable program code means comprising:
means for providing a user friendly graphical interface by which a user may analyze past airport surface operations data;
means for importing data and conducting automated analysis to derive data values pertaining to airport surface operations;
means for selecting data elements and limiting the derived data values by setting conditional value constraints;
means for storing the derived data values;
means for plotting the derived data values on a map of an the airport;
means for handling data interaction to allow users or administrators to alter configuration files; and
means to allow the user to manually edit airport adaptation data using a graphical interface and re-save the updated adaptation files.

2. A computer-readable medium having computer executable instructions for providing visual airport surface and terminal area data the computer-executable instructions performing steps comprising:
fusing multiple surveillance and flight data sources to provide analysis functionality for both airborne and surface based flights;
providing a range of data to make intelligent categorization and derived data analysis decisions;
implementing logic for matching flights to corresponding data messages by maintaining its own key mappings between data tables during import so that keys are unique to an installation and do not require sequences;
exporting datasets through the PostgreSQL dump utility and then import it into an existing database without creating overlapping, duplicate or conflicting keys; and
sharing previously processed datasets after a quick restore.
